(19) United States
(12) Patent Application Publication
(10) Pub. No.: US 2026/0346510 A1
(43) Pub. Date: Nov. 5, 2026

(54) INTERCHANGEABLE MOLD ASSEMBLIES AND METHODS OF USE THEREOF

(71) Applicant: Sanford, L.P., Atlanta, GA (US)

(72) Inventors: Stan Chudzik, Alpharetta, GA (US); Michael Jourden, Atlanta, GA (US); Melanie Kregg, Atlanta, GA (US); Marjavis J. Matthis, Atlanta, GA (US); Andrew Phillip Kitchens, Kennesaw, GA (US); Jessica Tebbe, Alpharetta, GA (US)

(21) Appl. No.: 19/112,535

(22) PCT Filed: Sep. 7, 2023
(86) PCT No.: PCT/US2023/032152

§ 371 Date: Mar. 17, 2025

Related U.S. Application Data
(60) Provisional application No. 63/407,272, filed on Sep. 16, 2022.

(51) Int. Cl. B29C 39/26; B29C 39/02

(52) U.S. Cl. CPC B29C 39/26; B29C 39/02

(57) ABSTRACT

Interchangeable mold assemblies and methods of use thereof are provided to permit a user to create a variety of character combinations by connecting a first mold, e.g., a head mold, of one character with a second mold, e.g., a body mold, of a different character to assemble a full mold of a new character, which is a combination of the two different characters. The head and body molds may each be formed of a two piece construction, e.g., the front and back half of the head or body, which may be assembled together. A curable material may be inserted into the connected molds such that, when cured, the curable material is permanently formed into a casting defining a single combined character.

### CROSS-REFERENCE TO RELATED APPLICATION

This application claims the benefit of U.S. Application Ser. No. 63/407,272, filed Sep. 16, 2022, the entirety of which is hereby incorporated by reference.

### TECHNICAL FIELD

The present disclosure relates generally to interchangeable mold assemblies that permit a user to create a multitude of permanent hybrid characters.

### BACKGROUND

Current mold assemblies allow users to form individual castings, which may be assembled with other individual castings to form a hybrid character. For example, each casting may be a head, a torso, arms, legs, etc., which is individually molded and subsequently assembled together. The individual castings may be disassembled and reassembled to created new hybrid character combinations. A need remains for mold assemblies that provide users more creative options.

### BRIEF DESCRIPTION OF THE DRAWINGS

FIGS. 1A to 1C illustrate various views of a two-piece mold assembly in a closed configuration constructed in accordance with the principles of the present disclosure.

FIGS. 2A to 2D illustrate various views of the two-piece mold assembly of FIG. 1A in an open configuration in accordance with the principles of the present disclosure.

FIGS. 3A and 3B illustrate various views of an alternative mold piece constructed in accordance with the principles of the present disclosure.

FIG. 4 illustrates an alternative two-piece mold assembly in an open configuration constructed in accordance with the principles of the present disclosure.

FIGS. 5A-5E illustrate alternative two-piece mold assemblies in a closed configuration in various perspective views in accordance with the principles of the present disclosure.

FIGS. 6A-6D illustrate various two-piece mold assemblies of FIGS. 5A-5E in an open configuration in various views in accordance with the principles of the present disclosure.

FIGS. 7A-7H illustrate various individual assembly components of the two-piece mold assemblies of FIGS. 5A-5E in an open configuration in various views in accordance with the principles of the present disclosure.

FIGS. 8A-8E illustrate various individual assembly components for two-piece mold assemblies in a closed configuration, and close up views of engagement portions of the individual assembly components in various views in accordance with the principles of the present disclosure.

FIGS. 9A-9B illustrate various engagement features for individual assembly components two-piece mold assemblies in accordance with the principles of the present disclosure.

The detailed description is set forth with reference to the accompanying drawings The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

The interchangeable mold assemblies and methods described herein enables the user, e.g., children, to create a variety of character combinations of their choice by connecting a first mold, e.g., a head mold, of one character with a second mold, e.g., a body mold, of a different character to assemble a full mold of a new character, which is a combination of the two different characters. For example, the character head mold of a frog may be combined with the character body mold of an owl to form a full mold of a newly created character, e.g., a “frowl”, such that the casting created from the full mold has the head of a frog and a body of an owl. Similarly, the character head mold of the owl may be combined with the character body mold of the frog to form a full mold of a newly created character, e.g., an “owrog”, such that the casting created from the full mold has the head of the owl and a body of the frog. The castings may be created by pouring a curable material, e.g., one or more resins such as silicone, urethanes, or other alternative resins and/or harder materials such as clay, foams, epoxy, or polyurethane, into the connected molds, such that when cured, the curable material is permanently formed into a single combined character. Depending on the curable material, the castings formed may be soft and “squishy” or hard like plastic. In addition, additional materials may be mixed in with the curable material prior to casting, e.g., glitter flakes, colorants such as dyes and pigments, glow-in-the-dark pigments, etc.

The head mold may be formed of a two piece construction, e.g., the front and back half of the head or the right and left side of the head, which may be assembled together. Similarly, the body mold may be formed of a two piece construction, e.g., the front and back half of the body or the right and left side of the body, which may be assembled together. Accordingly, with even a limited number of different character molds, the user can create a multitude of character combinations, e.g., with between 10 and 80 different character molds, the potential amount of hybrid character combinations can be in the thousands. For example, the estimated number of character combinations with 60 characters is 1,770, and for 80 characters is 3,160. As will be understood by a person having ordinary skill in the art, the character molds described herein are not limited to animal characters, but may include other features including, but not limited to robots, people, foods, artistic shapes, geometric shapes such as spheres, cubes, cones, etc., activity games, furniture, storage components, sports, tools, vehicles, fantasy, sci-fi, etc.

In addition, more than two molds may be coupled together such that the casting created by the connected molds will form a character defined by the features of each connected mold. For example, the various molds may be stacked on top of each other like a totem pole to create the overall character, e.g., head mold, arms and shoulders mold, torso mold, and legs mold of a character. Moreover, the molds may be configured to permit the user to add various accessories to the curable material during curing that enable additional features to be incorporated into the resulting casting. For example, the accessories may include suspending lights, e.g., LED, LCD, or incandescent light features, which may be battery powered, connection features, and/or plugs that may be removed after casting that create pre-formed cavities for subsequent insertion of additional components such as a squeaker or connection feature. The connection feature may be a snap-on tool configured to permit removable coupling with other castings. Accordingly, each casting formed by the connected molds may be removeably coupled to other castings formed by other connected molds via the connection feature(s) to form a larger assembly of castings, thereby increasing the creative options in casting for the user. Additionally, the castings may be removably coupled to other castings in the form of clothing via the connection features.

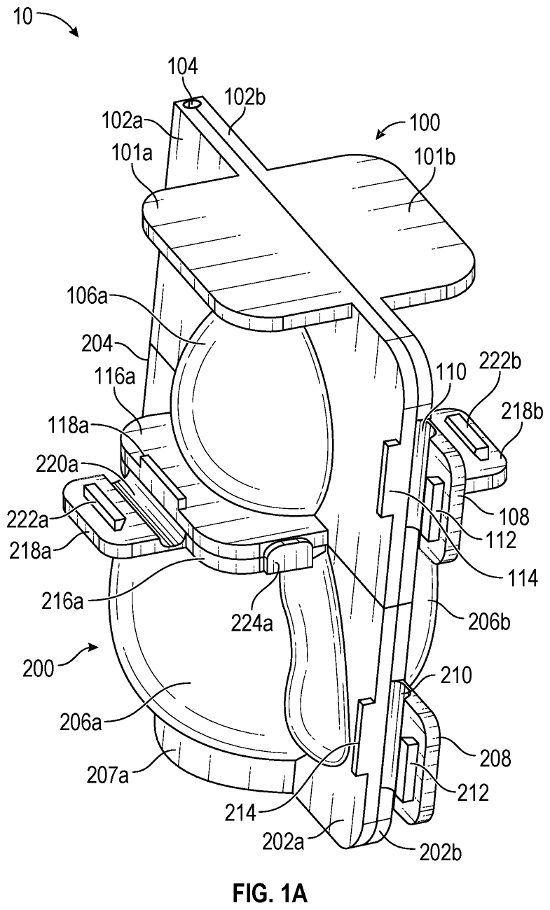

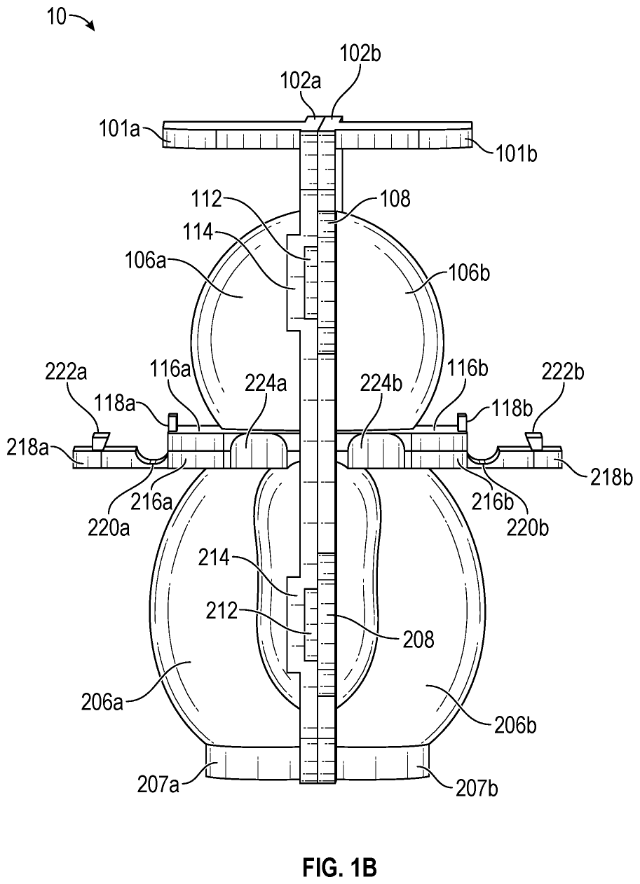

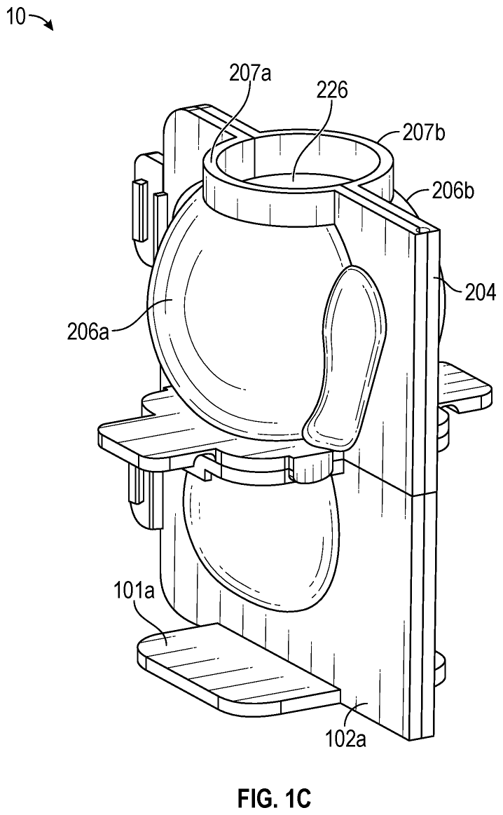

Referring now to FIGS. 1A to 1C, an interchangeable mold assembly is provided. Interchangeable mold assembly 10 may be formed by two or more individual mold frames, e.g., upper mold frame 100 and lower mold frame 200, each having a cavity defining a respective feature of a character or component, which may be removeably coupled together. The mold frames described herein may be made of one or more of a variety of resins, e.g., acrylonitrile butadiene styrene (ABS), polystyrene, high impact polystyrene, polyethylene, polycarbonate, styrene-acrylonitrile (SAN), etc., or preferably polypropylene.

Upper mold frame 100 may be selected from a plurality of upper mold frames, each associated with a specific character or component, and lower mold frame 200 may be selected from a plurality of lower mold frames, each associated with a specific character or component. For example, the specific characters may include animals such as an owl, frog, bear, dog, cat, alligator, elephant, etc. Accordingly, upper mold frame 100 may be selected from a mold frame defining an owl such that upper mold frame 100 defines an owl head, and lower mold frame 200 may be selected from a mold frame defining a frog such that lower mold frame 200 defines a frog body. Thus, when removably coupled together, the cavities of upper mold frame 100 and lower mold frame 200 may define a unique hybrid character having the head of an owl and the body of a frog. As will be understood by a person having ordinary skill in the art, the upper and lower mold frames may be selected from mold frames defining various character and/or components including, but not limited to robots, people, foods, artistic shapes, geometric shapes such as spheres, cubes, cones, etc., activity games, furniture, storage components, sports, tools, vehicles, fantasy, sci-fi, etc.

As shown in FIGS. 1A and 1B, upper mold frame 100 may include front mold frame 102a and back mold frame 102b, which may be pivotally coupled together via hinge assembly 104, e.g., a living hinge. Thus, front mold frame 102a and back mold frame 102b may be integrally formed and rotated between an open configuration and a closed configuration where front mold frame 102a is engaged with back mold frame 102b. Alternatively, front mold frame 102a and back mold frame 102b may be formed separately and may be assembled together via an attachment mechanism such as pegs and holes.

Moreover, front mold frame 102a may include cavity 106a, the interior surface of which may define a front half of a predefined feature, e.g., the front half of an owl head. Similarly, back mold frame 102b may include cavity 106b, the interior surface of which may define a back half of a predefined feature, e.g., the back half of the owl head. Accordingly, when front mold frame 102a and back mold frame 102b are in the closed configuration, cavity 106a and cavity 106b may be aligned to define the complete predefined feature, e.g., the owl head. Moreover, cavities 106a and 106b may be shaped, such that when aligned, provide an opening to permit fluid communication with the cavity of lower mold frame 200, as described in further detail below.

As shown in FIGS. 1A and 1B, front mold frame 102a and back mold frame 102b each may include a flat portion extending around cavity 106a and cavity 106b, respectively. Thus, in the closed configuration, the flat portion of front mold frame 102a may engage with the flat portion of back mold frame 102b. As shown in FIG. 1A, the flat portion of back mold frame 102b may include clasp 108 extending therefrom via hinge 110, such that clasp 108 may be rotated relative to back mold frame 102b via hinge 110. In addition, clasp 108 may include protrusion 112 defining a groove sized and shaped to releasably engage with lip 114 of front mold frame 102a. Clasp 108 and lip 114 may be positioned on a side of back mold frame 102b and front mold frame 102a, respectively, opposite to hinge assembly 104, such that in the closed configuration, clasp 108 may be moved from an open position to a closed positioned where lip 114 is received by the groove of protrusion 112 of clasp 108, e.g., a “snap-over tab” method, to thereby secure back mold frame 102b to front mold frame 102a, e.g., via an interference fit connection.

Upon application of a sufficient force to clasp 108, lip 114 may be disengaged from the groove of protrusion 112, such that clasp 108 may be moved from the closed position back to the open position and front mold frame 102a and back mold frame 102b may be moved from the closed configuration back to the open configuration, e.g., to remove the casting therein. As will be understood by a person having ordinary skill in the art, front mold frame 102a may have a hinged clasp instead of lip 114 and back mold frame 102b may have a lip instead of clasp 108. Additionally or alternatively, upper mold frame 100 may include a locking mechanism other than the hinged clasp/lip locking mechanism described above, e.g., a key locking mechanism where another component may be inserted into a hole of front and back mold frames 102a, 102b and a key is twisted to engage a ramping locking geometry on the key or front and back mold frames 102a, 102b to thereby tightly secure front mold frame 102a to back mold frame 102b. Alternatively, the locking mechanism may include rubber bands or a screw mechanism.

In addition, front mold frame 102a may include flat platform 116a extending therefrom, e.g., in a direction perpendicular to the direction from hinge assembly 104 to lip 114. Flat platform 116a may include lip 118a configured to releasably engage with a hinged clasp of lower mold assembly 200 via a similar locking mechanism provided by clasp 108 and lip 114, as described in further detail below. Similarly, back mold frame 102b may include flat platform 116b extending therefrom, e.g., in a direction perpendicular to the direction from hinge assembly 104 to clasp 108. Flat platform 116b also may include lip 118b configured to releasably engage with a hinged clasp of lower mold assembly 200 via a similar locking mechanism provided by clasp 108 and lip 114.

Front mold frame 102a further may include flat portion 101a extending therefrom, e.g., in a direction parallel to flat platform 116a, and back mold frame 102b further may include flat portion 101b extending therefrom, e.g., in a direction parallel to flat platform 116b. Accordingly, in the closed configuration, flat portions 101a, 101b may form a base to provide a stable surface to interchangeable mold assembly 10, e.g., when interchangeable mold assembly 10 is upside-down, to maintain interchangeable mold assembly 10 in position while the curable material is poured therein and during the casting process, as shown in FIG. 1C.

Moreover, lower mold frame 200 may include front mold frame 202a and back mold frame 202b, which may be pivotally coupled together via hinge assembly 204, e.g., a living hinge. Thus, front mold frame 202a and back mold frame 202b may be integrally formed and rotated between an open configuration and a closed configuration where front mold frame 202a is engaged with back mold frame 202b. Alternatively, front mold frame 202a and back mold frame 202b may be formed separately and may be assembled together via an attachment mechanism such as pegs and holes.

Moreover, front mold frame 202a may include cavity 206a, the interior surface of which may define a front half of a predefined feature, e.g., the front half of a frog body. Similarly, back mold frame 202b may include cavity 206b, the interior surface of which may define a back half of a predefined feature, e.g., the back half of the frog body. Accordingly, when front mold frame 202a and back mold frame 202b are in the closed configuration, cavity 206a and cavity 206b may be aligned to define the complete predefined feature, e.g., the frog body. Moreover, cavities 206a and 206b may be shaped, such that when aligned, provide an opening to permit fluid communication with the cavity of upper mold frame 100 when lower mold frame 200 is removably coupled to upper mold frame 100. Accordingly, the curable material inserted into either the cavity of upper mold frame 100 or lower mold frame 200 may flow into the other cavity for curing.

As shown in FIGS. 1A and 1B, front mold frame 202a and back mold frame 202b each may include a flat portion extending around cavity 206a and cavity 206b, respectively. Thus, in the closed configuration, the flat portion of front mold frame 202a may engage with the flat portion of back mold frame 202b. As shown in FIG. 1A, the flat portion of back mold frame 202b may include clasp 208 extending therefrom via hinge 210, such that clasp 208 may be rotated relative to back mold frame 202b via hinge 210. In addition, clasp 208 may include protrusion 212 defining a groove sized and shaped to releasably engage with lip 214 of front mold frame 202a. Clasp 208 and lip 214 may be positioned on a side of back mold frame 202b and front mold frame 202a, respectively, opposite to hinge assembly 204, such that in the closed configuration, clasp 208 may be moved from an open position to a closed positioned where lip 214 is received by the groove of protrusion 212 of clasp 208, e.g., a “snap-over tab” method, to thereby secure back mold frame 202b to front mold frame 202a, e.g., via an interference fit connection.

Upon application of a sufficient force to clasp 208, lip 214 may be disengaged from the groove of protrusion 212, such that clasp 208 may be moved from the closed position back to the open position and front mold frame 202a and back mold frame 202b may be moved from the closed configuration back to the open configuration, e.g., to remove the casting therein. As will be understood by a person having ordinary skill in the art, front mold frame 202a may have a hinged clasp instead of lip 214 and back mold frame 202b may have a lip instead of clasp 208. Additionally or alternatively, lower mold frame 200 may include a locking mechanism other than the hinged clasp/lip locking mechanism described above, e.g., a key locking mechanism, rubber bands, a screw mechanism, etc., as described above.

In addition, front mold frame 202a may include flat platform 216a extending therefrom, e.g., in a direction perpendicular to the direction from hinge assembly 204 to lip 214. Flat platform 216a may include clasp 218a extending therefrom via hinge 220a, such that clasp 218a may be rotated relative to flat platform 216a via hinge 220a. In addition, clasp 218a may include protrusion 222a defining a groove sized and shaped to releasably engage with lip 118a of flat platform 116a when flat platform 216a is aligned and engaged with flat platform 116a. In some embodiments, flat platform 216a may further include one or more supports 224a, e.g., positioned on opposite sides of flat platform 216a, and extending upward to engage with and secure flat platform 116a relative to flat platform 216a when upper mold frame 100 is removably coupled to lower mold frame 200.

Similarly, back mold frame 202b may include flat platform 216b extending therefrom, e.g., in a direction perpendicular to the direction from hinge assembly 204 to clasp 208. Flat platform 216b also may include clasp 218b extending therefrom via hinge 220b, such that clasp 218b may be rotated relative to flat platform 216b via hinge 220b. In addition, clasp 218b may include protrusion 222b defining a groove sized and shaped to releasably engage with lip 118b of flat platform 116b when flat platform 216b is aligned and engaged with flat platform 116b. In some embodiments, flat platform 216b may further include one or more supports 224b, e.g., positioned on opposite sides of flat platform 216b, and extending upward to engage with and secure flat platform 116b relative to flat platform 216b when upper mold frame 100 is removably coupled to lower mold frame 200.

Front mold frame 202a further may include edge 207a extending along a lower edge of cavity 206a, e.g., on a side opposite to where front mold frame 202a is removably coupled to front mold frame 102a, and back mold frame 202b further may include edge 207b extending along a lower edge of cavity 206b, e.g., on a side opposite to where front mold frame 202b is removably coupled to front mold frame 102b, such that edges 207a, 207b define inlet 226 when front mold frame 202a and back mold frame 202b are in the closed position. Inlet 226 may be sized and shaped to receive the curable material therethrough, e.g., by pouring the curable material into inlet 226, to fill the cavities of upper mold frame 100 and lower mold frame 200 with the curable material. As shown in FIG. 1C, interchangeable mold assembly 10 may be positioned upside-down, e.g., on a flat surface via flat portions 101a, 101b or in the user's hands, such that inlet 226 is directed upward. Thus, gravity may assist in the curable material filling the cavities of upper mold frame 100 and lower mold frame 200. As will be understood by a person having ordinary skill in the art, the inlet may be positioned in other portions of interchangeable mold assembly 10.

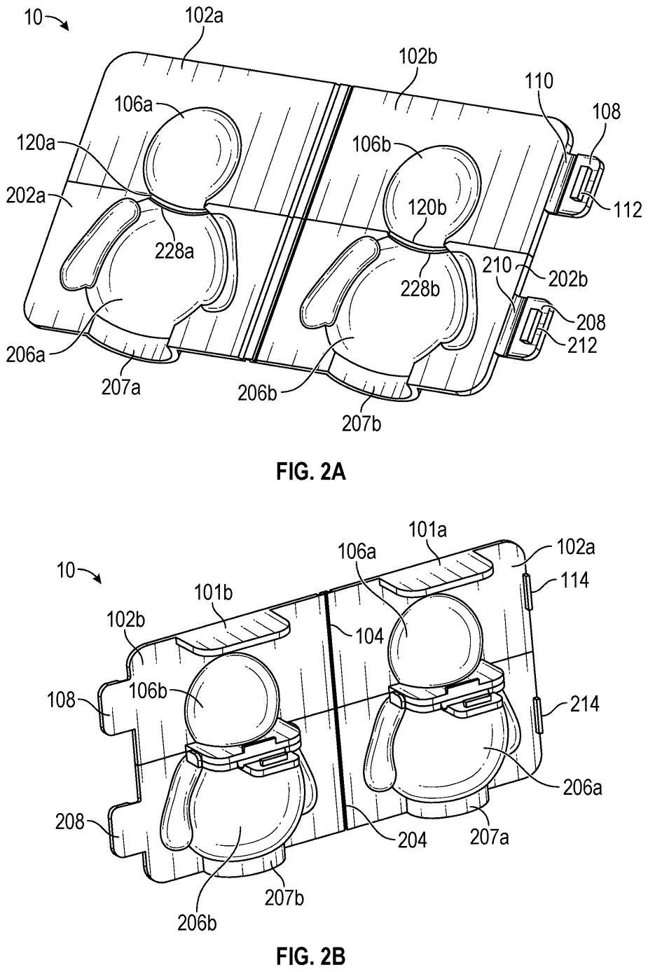

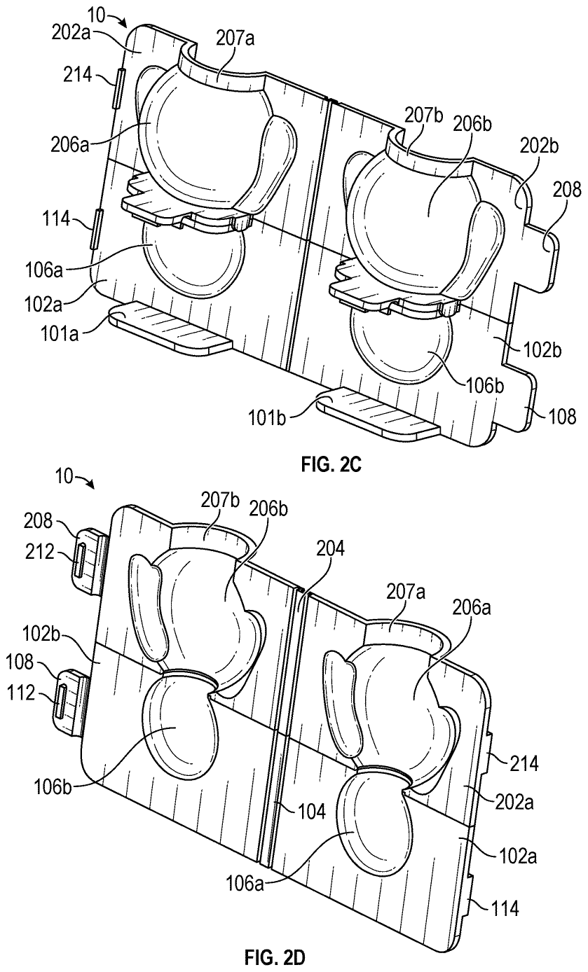

FIGS. 2A to 2D illustrate interchangeable mold assembly 10, e.g., front mold frames 102a, 202a and back mold frames 102b, 202b, in the open configuration. As shown in FIG. 2A, front mold frame 102a may include edge 120a extending along a lower edge of cavity 106a, such that edge 120a is configured to be removably secured to edge 228a extending along an upper edge of cavity 206a, e.g., on a side of cavity 206a opposite to edge 120a. Accordingly, edge 120a may have a geometry corresponding with edge 228a to thereby facilitate engagement between front mold frame 102a and front mold frame 202a. The respective geometries of edges 120a, 228a may be selected to provide a sealing function, e.g., a treacherous path to prevent or otherwise reduce leakage of the curable material within interchangeable mold assembly 10. For example, edge 120a may have a U-shaped protrusion and edge 228a may have a corresponding inverted U-shaped groove sized and shaped to securely receive the U-shaped protrusion of edge 120a, via a “ship-lap” joint, or vice versa. Alternatively, the respective geometries of edges 120a, 228a may include a “flash-trap” sealing mechanism including a tongue and groove assembly, or a T shaped sliding component and a T shaped slot sized and shaped to receive the T shaped sliding component to form the seal.

Similarly, front mold frame 102b may include edge 120b extending along a lower edge of cavity 106b, such that edge 120b is configured to be removably secured to edge 228b extending along an upper edge of cavity 206b, e.g., on a side of cavity 206b opposite to edge 120b. Like edges 120a, 228a, edge 120b may have a geometry corresponding with edge 228b to thereby facilitate engagement between front mold frame 102b and front mold frame 202b, as well as provide a sealing function, as described above.

Prior to adding the curable material to interchangeable mold assembly 10, the user may prepare the curable material, e.g., if the curable material requires mixing two or more materials together to form the curable material. For example, the user may be required to mix the multiple materials together, e.g., in a mixing cup, to form a homogenous curable material, which may then be inserted, e.g., poured, into interchangeable mold assembly 10 via inlet 226. In some embodiments, the curable material may be inserted into the cavities of interchangeable mold assembly 10 using other delivery systems and methods than pouring, e.g., injecting the curable material via a syringe or an epoxy dual barrel syringe system, or utilizing a mixing pouch for mixing multiple curable materials together and which permits the user to dispense the mixed curable material into interchangeable mold assembly 10 without making a mess.

As described above, the curable material may include curable resin materials such as polyurethanes and silicones. The curable materials may be selected based on, e.g., the “pot life” of the curable materials, which is the amount of working time once two or more curable materials are mixed together, the cure time, which is the amount of time the mixture requires to fully cure, and the durometer of the cured materials, which is the softness grade of the curable material mixture, e.g., measured in Shore A or Shore 00 scales. An estimated viscosity range in centipoise for a Part A material and Part B material (to be mixed together to form the curable mixture, is provided in the table below.

| Viscosity (cps) | Minimum | Target | Maximum |
|---|---|---|---|
| Part A material | 5000 | 7000 | 10000 |
| Part B material | 10000 | 14000 | 18000 |
| Mixture of Part A & | 18000 | 22000 | 26000 |
| Part B | | | |

The durometer range for the softness of the casted resin may fall in a range of between 4-20 Shore A or Shore 00. The “pot” life or working time may be between 5-15 minutes or longer, and the cure time may be between 10-60 minutes, or preferably between 15-45 minutes, or preferably 30 minutes for the casting material to cure.

In addition, the user may mix additional materials with the curable materials prior to casting, e.g., glitter flakes, colorants such as dyes and pigments, glow-in-the-dark pigments, etc. Moreover, the user may create multiple curable mixtures, each having different additives, such that the curable mixtures may be selectively inserted into interchangeable mold assembly 10 to produce a permanent hybrid character having different properties, e.g., color or glitter.

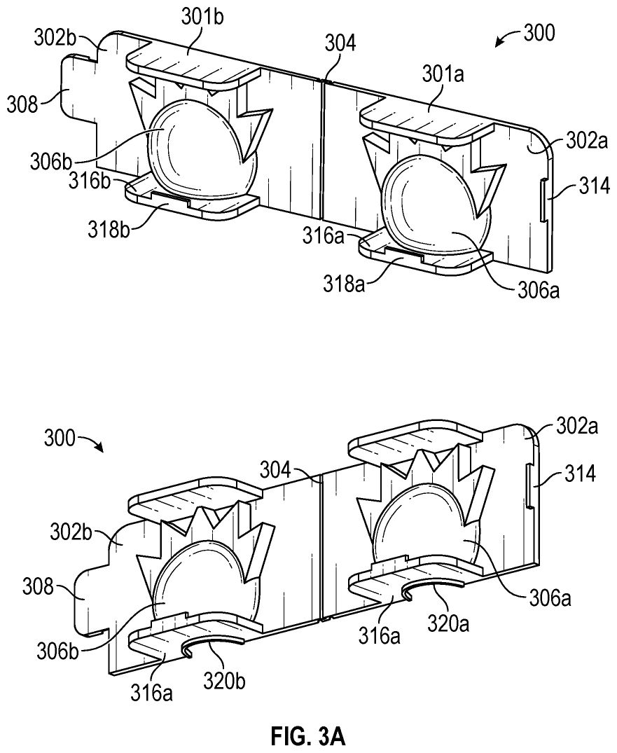

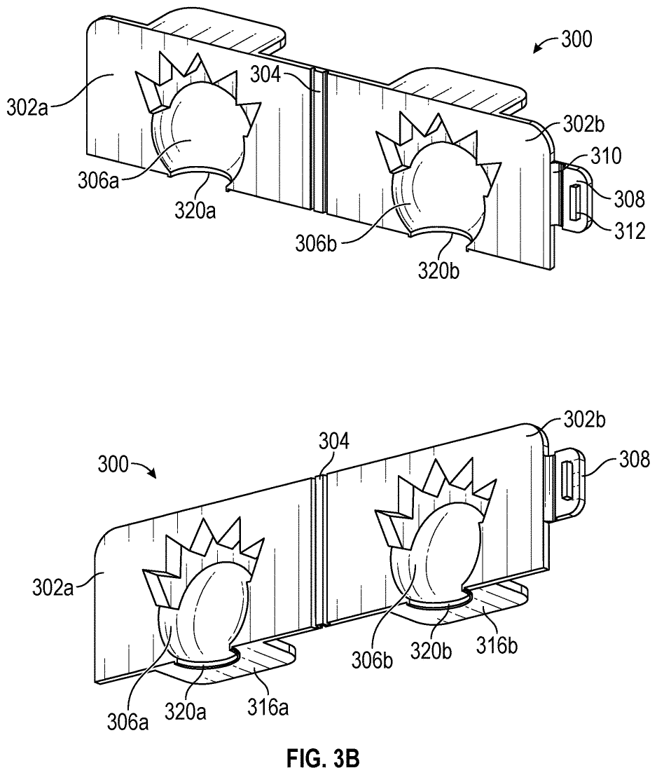

FIGS. 3A to 3B illustrate another upper mold frame 300, which may be selected from a plurality of upper mold frames for removably coupled with a selected lower mold frame to create a unique permanent hybrid character, as described above. Upper mold frame 300 may be constructed similar to upper mold frame 100 for purposes of removably coupling with a lower mold frame, e.g., lower mold frame 200. For example, upper mold frame 300 may include flat portions 301a, 301b, front mold frame 302a, back mold frame 302b, hinge assembly 304, cavities 306a, 306b, flat platforms 316a, 316b having lips 318a, 318b, respectively, and edges 320a, 320b, which correspond with flat portions 101a, 101b, front mold frame 102a, back mold frame 102b, hinge assembly 104, cavities 106a, 106b, flat platforms 116a, 116b having lips 118a, 118b, respectively, and edges 120a, 120b of upper mold frame 100. Upper mold frame 300 may differ from upper mold frame 100 in that the interior surfaces of cavities 306a, 306b, when aligned, define a feature associated a character that is different from the character associated with upper mold frame 100.

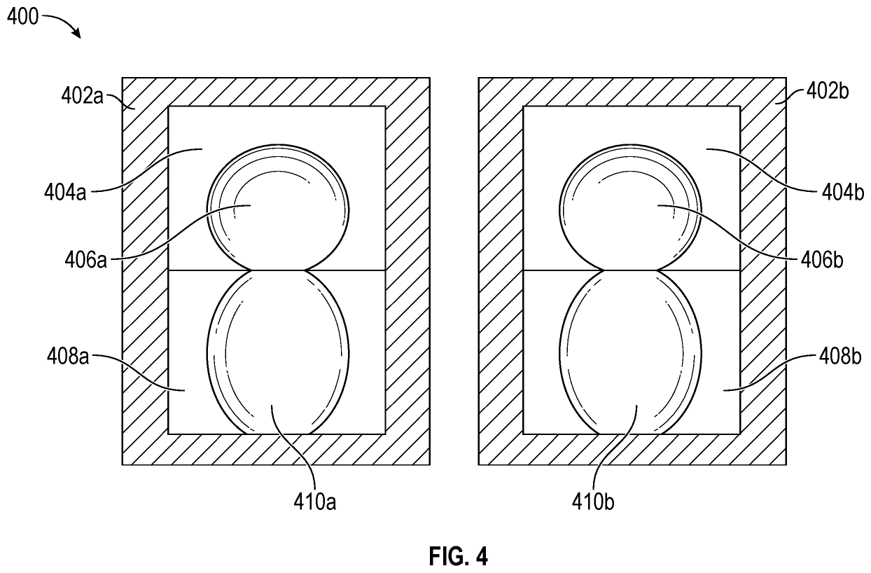

Referring now to FIG. 4, an alternative interchangeable mold assembly is provided. Interchangeable mold assembly 400 may include front frame 402a and back frame 402b, which may be removably coupled to front frame 402a to form a character mold. Front frame 402a may have a cavity sized and shaped to receive two or more inserts, e.g., upper insert 404a having cavity 406a defining the front half of an upper feature of a first character, and lower insert 408a having cavity 410a defining the front half of a lower feature of a second character which may be different from the first character. For example, upper and lower inserts 404a, 408a, may be removably coupled to front frame 402a via a snap connection.

Similarly, back frame 402b may have a cavity sized and shaped to receive two or more inserts, e.g., upper insert 404b having cavity 406b defining the back half of an upper feature of a third character which may be the same as or different from the first character, and lower insert 408b having cavity 410b defining the back half of a lower feature of a fourth character which may be the same as or different from the second character. Like upper and lower inserts 404a, 408a, upper and lower inserts 404b, 408b, may be removably coupled to back frame 402b via a snap connection. After upper and lower inserts 404a, 408a and upper and lower inserts 404b, 408b are inserted within front frame 402a and back frame 402b, respectively, front frame 402a may be removably coupled to back frame 402b, e.g., via any of the locking mechanism described above, such that a curable mixture may be inserted within the cavities of interchangeable mold assembly 400 to form a permanent hybrid character in accordance with the principles of the present disclosure described herein.

As will be understood by a person having ordinary skill in the art, alternative embodiments may utilize alternative manufacturing processes other than injection molding described herein. For example, the manufacturing process may utilize vacuum-forming the mold halves either separately or integrally and implementing a living hinge to assemble the separate components. The vacuum-forming method may greatly reduce the overall cost of the mold construction and amount of plastic resin used for the molds. Additionally or alternatively, flexible materials such as thermoplastic elastomers (TPE), Styrene-ethylene-butylene-styrene (SEBS), or polyvinyl chloride (PVC), may be used and molded to form sections of a character, e.g., head and body or head, neck and shoulders, torso, arms, legs, etc., and stacked together via mechanical locking features. The assembled mold components may possess similar geometries as described above to prevent leakage of the curable material while allowing the flexibility to be easily removed as the flexible materials would permit the user to stretch and peel off the mold from the cured casting. Moreover, the flexible mold components may be attached using secondary injection molded “coupling” joint components. Accordingly, each mold section may essentially be a slice of a “tube,” which would not require opening like a traditional clam-shell mold.

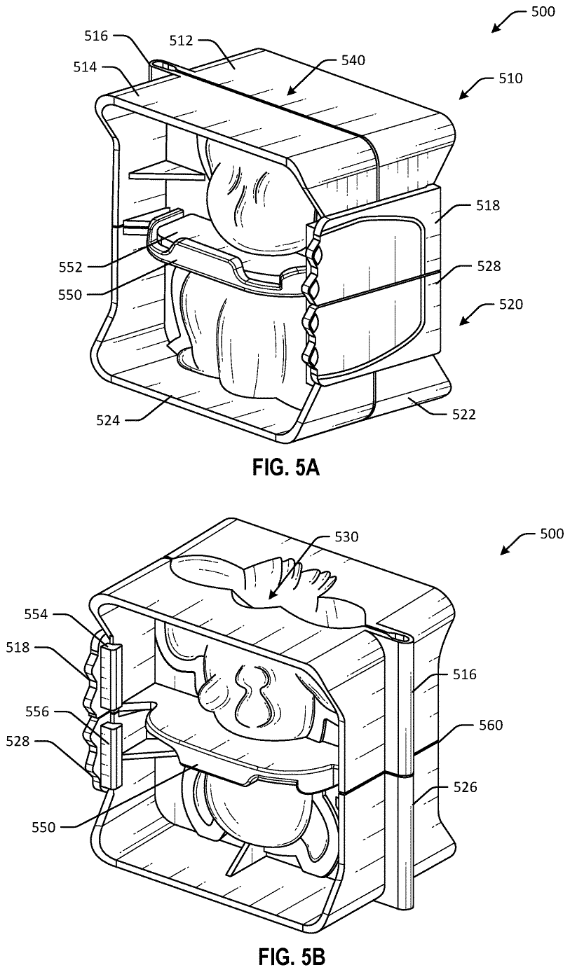

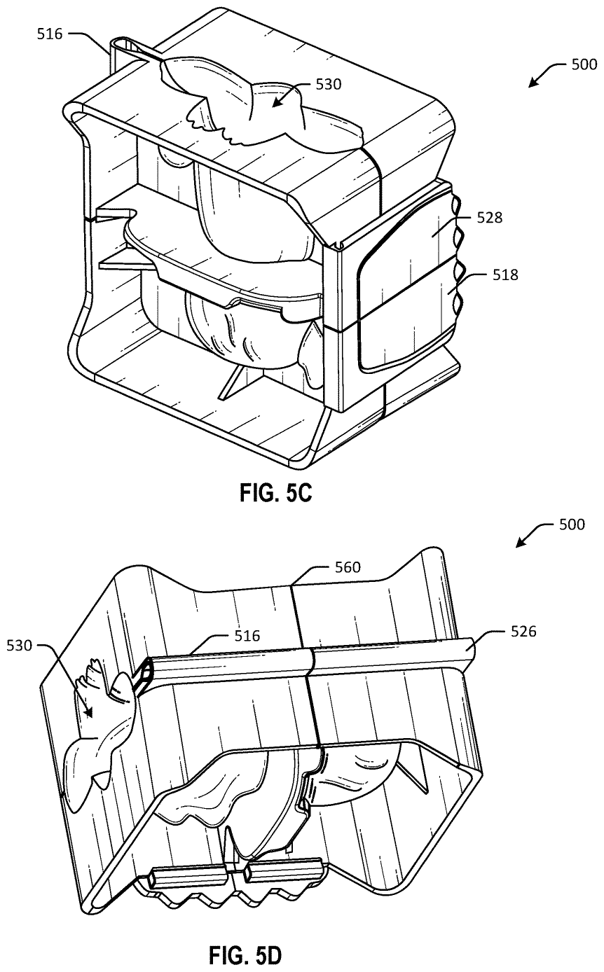

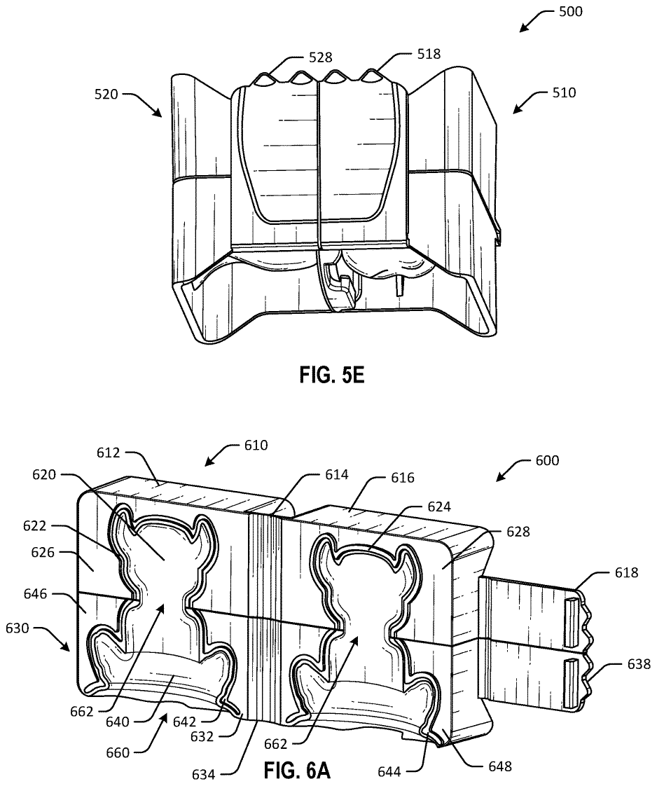

FIGS. 5A-5E illustrate alternative two-piece mold assemblies in a closed configuration in various perspective views in accordance with the principles of the present disclosure. A two-piece interchangeable mold assembly 500 is depicted in FIGS. 5A-5E. The interchangeable mold assembly 500 may be the same or different than the interchangeable mold assemblies discussed with respect to FIGS. 1-4.

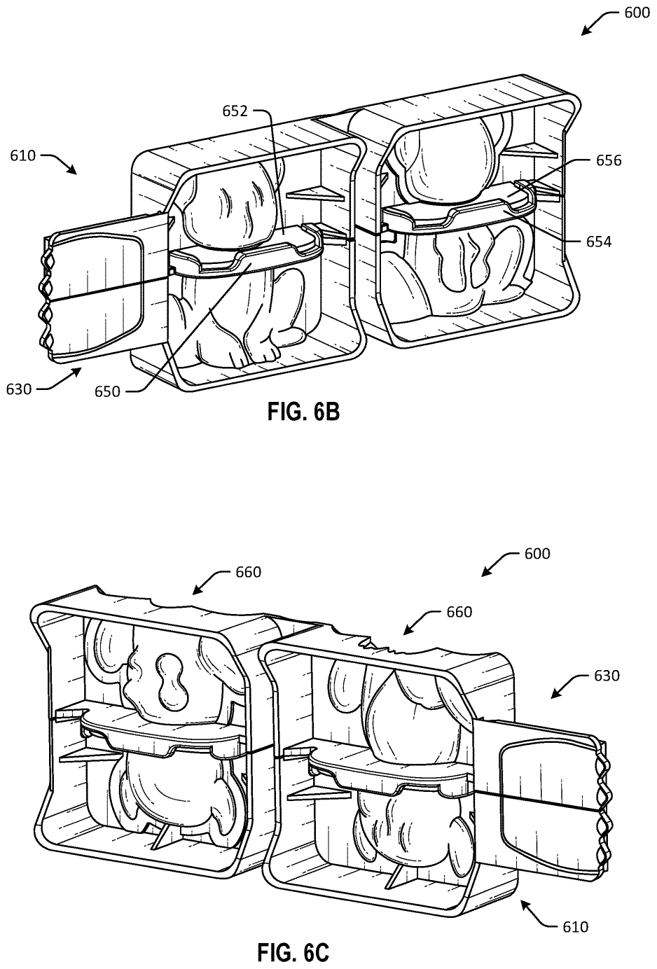

The interchangeable mold assembly 500 may include a first mold frame 520 and a second mold frame 510. The first mold frame 520 and the second mold frame 510 may be configured to be removeably coupled, and may be interchangeable and/or removeably coupled to other mold frames. The interchangeable mold assembly 500 may be separated along break 560. The first mold frame 520 may have a first cavity defining a first feature (e.g., first cavity 640 depicted in FIG. 6A, etc.). The first cavity may be configured to receive a curable material. The second mold frame 510 may have a second cavity defining a second feature (e.g., second cavity 620 depicted in FIG. 6A, etc.). The second cavity may be configured to receive the curable material. The second mold frame 510 may be configured to be removably coupled to the first mold frame 520 such that the second cavity is in fluid communication with the first cavity. After a predetermined time period, the curable material disposed within the first and second cavities can form a unitary casting defined by the first and second features.

The first cavity may have a first inlet 530 to receive the curable material and a first outlet disposed between the first mold frame 520 and the second mold frame 510. The second mold frame 510 (e.g., the second cavity) may have a second inlet configured to receive the curable material from the first cavity via the first outlet when the first mold frame 520 is coupled to the second mold frame 510, as discussed with respect to FIG. 6A.

The second mold frame 510 may have a flat portion 540 on an opposite side of the interchangeable mold assembly 500 from the first inlet 530. The flat portion 540 may be configured to maintain the interchangeable mold assembly 500 in a position such that the first inlet 530 is facing upward, as depicted in FIG. 5B.

The first mold frame 520 may include a first front mold frame 522 that forms a front half of the first cavity. The first mold frame 520 may include a first back mold frame 524 that forms a back half of the first cavity, where the first front mold frame 522 and the first back mold frame 524 can be coupled via a first living hinge 516. Other coupling mechanism may be used. Similarly, the second mold frame 510 may include a second front mold frame 512 that forms a front half of the second cavity, and a second back mold frame 514 that forms a back half of the second cavity, where the second front mold frame 512 and the second back mold frame 514 can be coupled via a second living hinge 526. Other coupling mechanism may be used.

One or more engagement features may be used to secure the first mold frame 520 to the first mold frame 510. For example, the first mold frame 520 may have a first engagement feature, and the second mold frame 510 may have a second engagement feature configured to mate with the first engagement feature to facilitate the removable coupling of the first and second mold frames 520, 510. In one example, the first engagement feature may be a receiving platform 550 having a lip, and the second engagement feature may be a flat platform 552 configured to slide under the lip of the receiving platform 550, so as to provide a slide and rail engagement feature that aligns the first and second mold frames and secures the first mold frame 520 to the second mold frame 510. In some embodiments, the first mold frame 520 may be an upper mold frame, and the second mold frame 510 may be a lower mold frame, whereas in other embodiments, the opposite may occur. Any number of mold frames may be secured together.

In some embodiments, such as that illustrated in FIGS. 5A-5E, the interchangeable mold assembly 500 may include an engagement mechanism or engagement feature configured to secure the first mold frame 520 to the second mold frame 510 when the second mold frame 510 is removeably coupled to the first mold frame 520, such as the flat platform 552 and the receiving platform 550. The receiving platform 550 may be a first platform extending from the first or second mold frame, and may include a lip. The flat platform may be a second platform extending from the first or second mold frame, and may be configured to engage with the first platform when the first mold frame 520 is removably coupled to the second mold frame 510. In some instances, the lip can be configured to secure the second platform to the first platform.

The individual mold frames may have individual locking or securing mechanisms that allow the individual mold frames to be secured in a closed configuration. For example, the first mold frame 520 may include a first hinged clasp 528 configured to secure the first mold frame 520 in a closed configuration. The second mold frame 510 may have a second hinged clasp 518 configured to secure the second mold frame 510 in a closed configuration. The first hinged clasp 528 may be a first living hinge, and the second hinged clasp 518 may be a second living hinge. The first hinged clasp 528 may have a securing tab 556 configured to engage a portion of the first mold frame 520 to secure the first mold frame 520 in the closed configuration, as depicted in FIG. 5B. The second hinged clasp 518 may have a securing tab 554 configured to engage a portion of the second mold frame 510 to secure the second mold frame 510 in the closed configuration, as depicted in FIG. 5B.

FIGS. 6A-6D illustrate various two-piece mold assemblies of FIGS. 5A-5E in an open configuration in various views in accordance with the principles of the present disclosure. The assemblies may be the same or different than the interchangeable mold assemblies discussed with respect to FIGS. 1-5E.

In FIGS. 6A-6D, an interchangeable mold assembly 600 is depicted in an open configuration. The interchangeable mold assembly 600 may include a first mold frame 630 removeably coupled to a second mold frame 610, both of which are in an open configuration. The first mold frame 630 may include a front portion 648 and a rear portion 632. The front portion 648 and the rear portion 632 may be coupled via a living hinge 634. The first mold frame 630 may form a first cavity 640 when in a closed configuration. The first mold frame 630 may have a sealing feature formed on an inner faces 646, 648 of the first mold frame 630. The sealing feature may be formed about a perimeter or outer edge of the first cavity 640. In some embodiments, the sealing feature may include a protrusion 642 formed on one side (e.g., front or rear portions, etc.) of the first mold frame 630, and a groove 644 formed on the other side, where the protrusion 642 engages the groove 644 when the first mold frame 630 is in a closed position. By engaging the groove 644, the protrusion 642 and groove 644 together may form a seal and prevent the curable material from leaking out of the first cavity 640 prior to curing. Moreover, in some embodiments, the inner faces 646, 648 may be textured so as to further prevent leakage of the curable material. The texture for the mating surfaces of the mold halves may be a MoldTech® texture having a texture depth is 0.0381 mm and draft angle is 2.5°. Other types of seals and/or leakage prevention may be used.

The first cavity 640 may have a first inlet 660 to receive the curable material and a first outlet 662 disposed between the first mold frame 630 and the second mold frame 610. The second mold frame 610 (e.g., the second cavity) may have a second inlet corresponding to the first outlet 662 configured to receive the curable material from the first cavity 640 via the first outlet 662 when the first mold frame 630 is coupled to the second mold frame 610. The first outlet 662 and second inlet may together allow for a continuous cavity to be formed between the two (or more) mold frames.

The second mold frame 610 may include a front portion 616 and a rear portion 612. The front portion 616 and the rear portion 612 may be coupled via a living hinge 614. The second mold frame 610 may form a second cavity 620 when in a closed configuration. The second mold frame 610 may have a sealing feature formed on an inner faces 626, 628 of the second mold frame 610. The sealing feature may be formed about a perimeter or outer edge of the second cavity 620. In some embodiments, the sealing feature may include a protrusion 622 formed on one side (e.g., front or rear portions, etc.) of the second mold frame 610, and a groove 624 formed on the other side, where the protrusion 622 engages the groove 624 when the second mold frame 610 is in a closed position. By engaging the groove 624, the protrusion 622 and groove 624 together may form a seal and prevent the curable material from leaking out of the second cavity 620 prior to curing. Moreover, in some embodiments, the inner faces 626, 628 may be textured so as to further prevent leakage of the curable material. The texture for the mating surfaces of the mold halves may be a MoldTech® texture having a texture depth is 0.0381 mm and draft angle is 2.5°. Other types of seals and/or leakage prevention may be used.

As discussed, the first mold frame 630 may have a receiving platform on the front and rear portions, such as a first receiving platform 650 on the front portion 616 and a second receiving platform 654 on the rear portion 612. The receiving platforms may receive corresponding flat platforms of the second mold frame 610, such as a first flat platform 652 of the front portion 612 and a second flat platform 656 of the rear portion 616 of the second mold frame 610.

The first mold frame 630 and the second mold frame 610 may be configured to independently open and close. The first mold frame 630 may include a first securing mechanism 618 and the second mold frame 610 may include a second securing mechanism 638, such that the first mold frame 630 is configured to be opened independent of the second mold frame 610, and the first mold frame 630 is configured to be closed independent of the second mold frame 620.

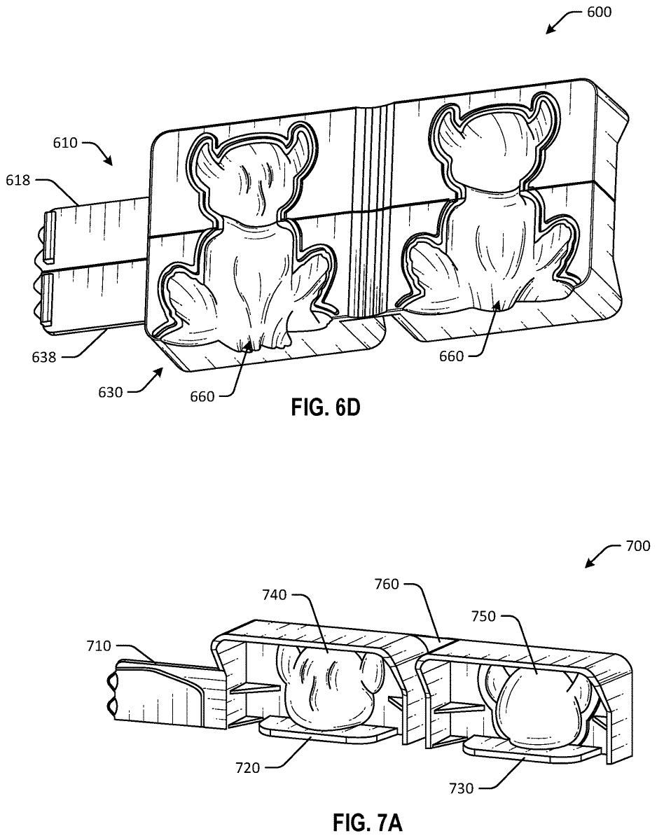

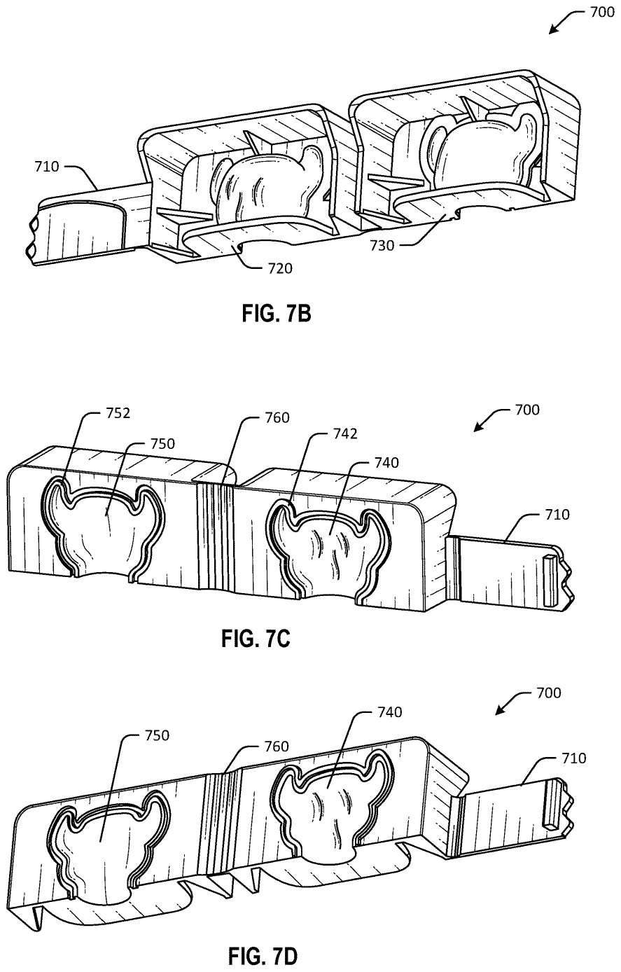

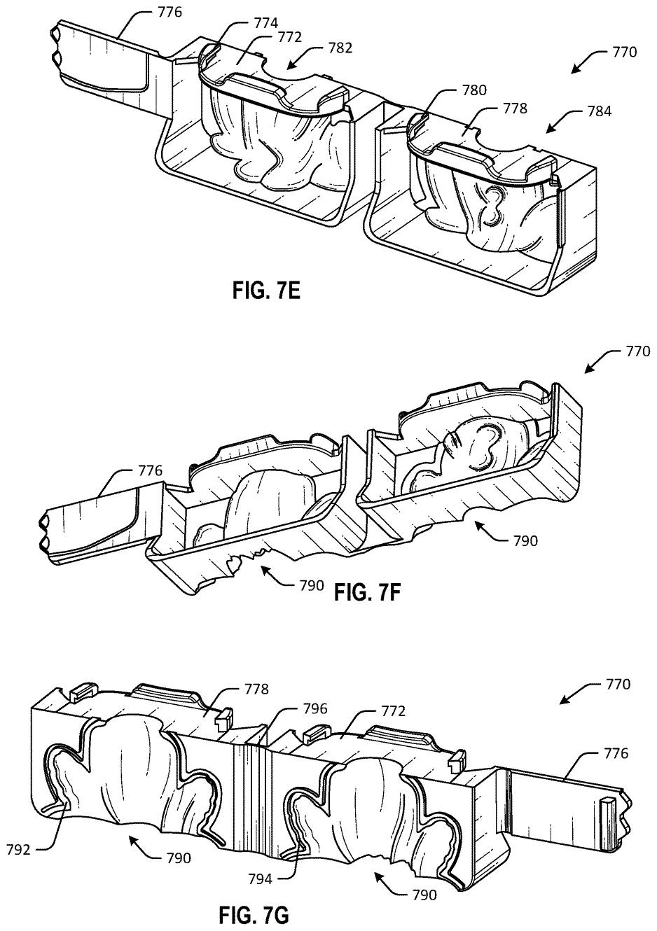

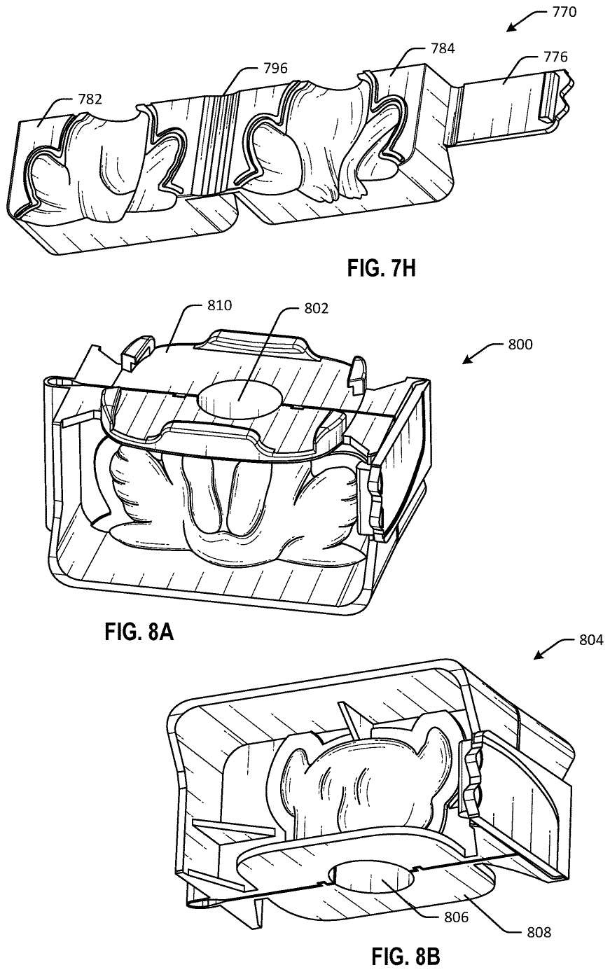

FIGS. 7A-7H illustrate various individual assembly components of the two-piece mold assemblies of FIGS. 5A-5E in an open configuration in various views in accordance with the principles of the present disclosure.

An interchangeable mold assembly may include a first mold frame 700 and a second mold frame 770. The first mold frame 700 may be an upper mold frame and may not have an external outlet, and the second mold frame 770 may be a lower mold frame and may include an external outlet 790 (external outlet 790 may be an opening and may be used to insert the curable material).

The first mold frame 700 may form an upper half of the interchangeable mold assembly and may have a front half portion 740 and a rear half portion 750 coupled via a living hinge 760. The first mold frame 700 may include a locking tab 710 and one or more engagement features to engage the second mold frame 770, such as a front flat platform 720 and a rear flat platform 730. The first mold frame 700 may include a tongue and groove sealing feature. For example, a front cavity portion 740 may have a groove 742 disposed about a perimeter of the front cavity portion 740, and a rear cavity portion 750 may have a protrusion or tongue 752 disposed about a perimeter of the rear cavity portion 750. The tongue 752 may engage the groove 742 to form a seal about the first cavity.

The second mold frame 770 may form a lower half of the interchangeable mold assembly and may have a front half portion 782 and a rear half portion 784 coupled via a living hinge 796. The second mold frame 770 may include a locking tab 776 and one or more engagement features to engage the first mold frame 700, such as a front receiving platform 772 having a lip 774, and a rear receiving platform 778 having a lip 780. The second mold frame 770 may include a tongue and groove sealing feature. For example, a front cavity portion may have a groove 794 disposed about a perimeter of the front cavity portion, and a rear cavity portion may have a protrusion or tongue 792 disposed about a perimeter of the rear cavity portion. The tongue 792 may engage the groove 794 to form a seal about the first cavity.

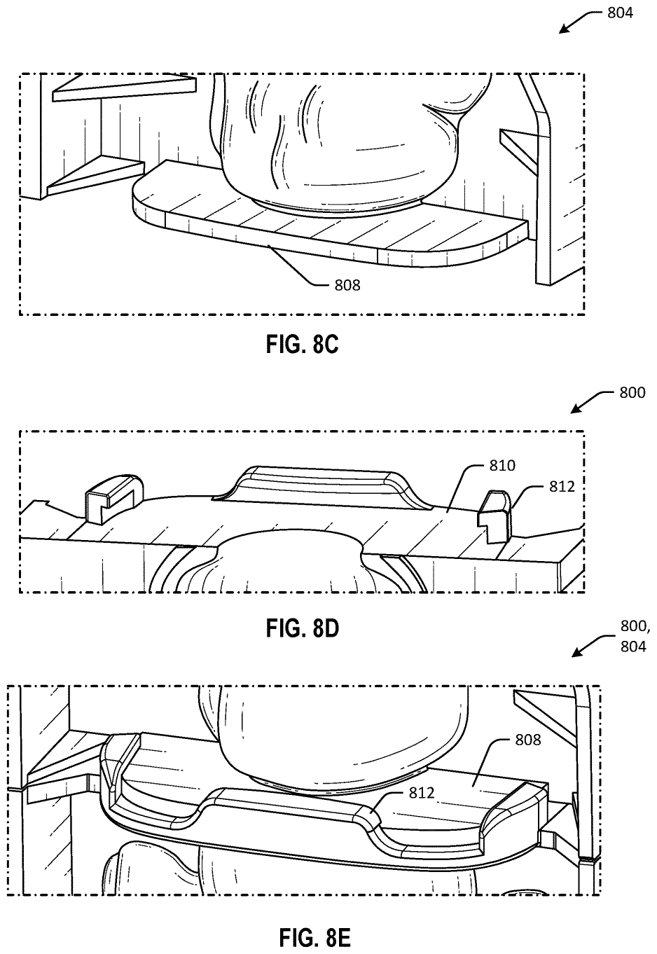

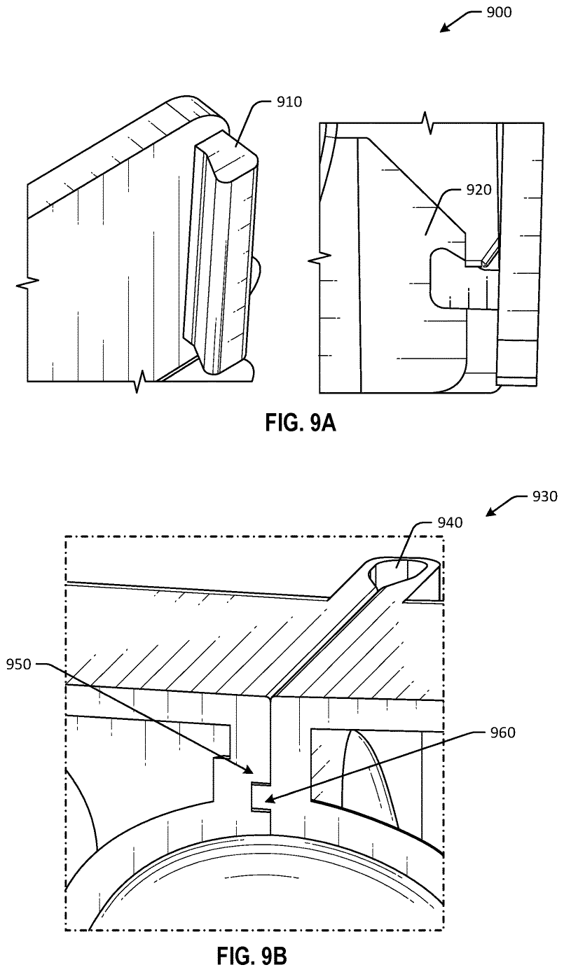

FIGS. 8A-8E illustrate various individual assembly components for two-piece mold assemblies in a closed configuration, and close up views of engagement portions of the individual assembly components in various views in accordance with the principles of the present disclosure.

In FIGS. 8A-8B, a first mold frame 800 is depicted in a closed configuration having a first outlet 802, and a second mold frame 804 is depicted in a closed configuration having a first inlet 806. The first mold frame 800 may have a second inlet on an opposite side of the first outlet 802. The first outlet 802 and the first inlet 806 may be aligned when the two mold frames are assembled, so as to provide a pathway for the curable material to flow. The first mold frame 800 may have a first receiving platform 810 to receive flat platform 808 of the second mold frame 804 to align and secure the two mold frames. The first receiving platform 810 may include a lip 812 extending from upper surface 830, under which the flat platform 808 may slide as depicted in FIG. 8E.

FIGS. 9A-9B illustrate various engagement features for individual assembly components two-piece mold assemblies in accordance with the principles of the present disclosure. In FIG. 9A, an example slide coupling mechanism 900 is depicted, where a member 910 may slide into groove 920 to secure two mold frames together. In FIG. 9B, a mold frame 930 is depicted in a closed configuration via living hinge 940, where the two halves of the mold frame can be aligned via a detent 950 and protrusion 960 feature. Other mechanisms may be used.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure.

While the present disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An interchangeable mold assembly comprising:
a first mold frame comprising a first cavity defining a first feature, the first cavity configured to receive a curable material; and
a second mold frame comprising a second cavity defining a second feature, the second cavity configured to receive the curable material, the second mold frame configured to be removably coupled to the first mold frame such that the second cavity is in fluid communication with the first cavity;
wherein, after a predetermined time period, the curable material disposed within the first and second cavities forms a unitary casting defined by the first and second features.

2. The interchangeable mold assembly of claim 1, wherein the first cavity comprises a first inlet to receive the curable material and a first outlet, and the second cavity comprises a second inlet configured to receive the curable material from the first cavity via the first outlet when the first mold frame is coupled to the second mold frame.

3. The interchangeable mold assembly of claim 2, wherein the second mold frame comprises a flat portion on an opposite side of the interchangeable mold assembly from the first inlet, the flat portion configured to maintain the interchangeable mold assembly in a position such that the first inlet is facing upward.

4. The interchangeable mold assembly of claim 1, wherein the first mold frame comprises a first engagement feature and the second mold frame comprises a second engagement feature configured to mate with the first engagement feature to facilitate the removable coupling of the first and second mold frames.

5. The interchangeable mold assembly of claim 1, wherein the first mold frame is configured to be opened independent of the second mold frame, and wherein the first mold frame is configured to be closed independent of the second mold frame.

6. The interchangeable mold assembly of claim 1, further comprising an engagement mechanism configured to secure the first mold frame to the second mold frame when the second mold frame is removeably coupled to the first mold frame.

7. The interchangeable mold assembly of claim 6, wherein the engagement mechanism comprises:
a first platform extending from the first or second mold frame, the first platform comprising a lip; and
a second platform extending from the first or second mold frame and configured to engage with the first platform when the first mold frame is removably coupled to the second mold frame, wherein the lip is configured to secure the second platform to the first platform.

8. The interchangeable mold assembly of claim 1, wherein the first mold frame comprises a first hinged clasp configured to secure the first mold frame in a closed configuration, and the second mold frame comprises a second hinged clasp configured to secure the second mold frame in a closed configuration.

9. The interchangeable mold assembly of claim 8, wherein the first hinged clasp comprises a first living hinge, and the second hinged clasp comprises a second living hinge.

10. The interchangeable mold assembly of claim 1, wherein the first mold frame comprises:
a first front mold frame comprising a front half of the first cavity; and
a first back mold frame comprising a back half of the first cavity, wherein the first front mold frame and the first back mold frame are coupled via a first living hinge; and
wherein the second mold frame comprises:
a second front mold frame comprising a front half of the second cavity; and
a second back mold frame comprising a back half of the second cavity, wherein the second front mold frame and the second back mold frame are coupled via a second living hinge.

11. The interchangeable mold assembly of claim 10, wherein the first front mold frame comprises a first flat front portion extending around the front half of the first cavity,
wherein the first back mold frame comprises a first flat back portion extending around the back half of the first cavity, the first flat back portion configured to engage with the second flat front portion when the first back mold frame is coupled to the first front mold frame,
wherein the second front mold frame comprises a second flat front portion extending around the front half of the second cavity,
wherein the second back mold frame comprises a second flat back portion extending around the back half of the second cavity, the second flat back portion configured to engage with the second flat front portion when the second back mold frame is coupled to the second front mold frame.

12. The interchangeable mold assembly of claim 11, wherein the first flat front portion, the first flat back portion, the second flat front portion, and the second flat back portion comprise textured surfaces.

13. The interchangeable mold assembly of claim 11, wherein the first back mold frame is coupled to the first front mold frame via a first hinge assembly configured to transition the first mold frame between a first open configuration and a first closed configuration where the front and back halves of the first cavity are aligned to define the first feature, and wherein the second back mold frame is coupled to the second front mold frame via a second hinge assembly configured to transition the second mold frame between a second open configuration and a second closed configuration where the front and back halves of the second cavity are aligned to define the second feature.

14. The interchangeable mold assembly of claim 13, wherein the first mold frame comprises a first sealing feature that forms an outline about the first cavity, and the second mold frame comprises a second sealing feature that forms an outline about the second cavity.

15. The interchangeable mold assembly of claim 1, further comprising:
a front housing comprising:
a first front insert configured to removably receive the first front mold frame; and
a second front insert configured to removably receive the second front mold frame; and
a back housing comprising:
a first back insert configured to removably receive the first back mold frame; and
a second back insert configured to removably receive the second back mold frame,
wherein the front housing is configured to be removably coupled to the back housing such that the front and back halves of the first cavity define the first feature and the front and back halves of the second cavity define the second feature.

16. The interchangeable mold assembly of claim 15, wherein the first and second front inserts and the first and second back inserts are configured to receive the first and second front mold frames and the first and second back mold frames, respectively, via a snap fit connection.

17. The interchangeable mold assembly of claim 1, further comprising:
one or more additional mold frames comprising one or more additional cavities defining one or more additional features, the one or more additional cavities sized and shaped to receive the curable material, the one or more additional mold frames configured to be removably coupled to the first or second mold frame such that the one or more additional cavities is in fluid communication with the first or second cavity,
wherein, after the predetermined time period, the curable material disposed within the first or second cavity and the one or more additional cavities forms a unitary casting defined by the first or second feature and the one or more additional features.

18. The interchangeable mold assembly of claim 1, further comprising:
one or more additional mold frames comprising one or more additional cavities defining one or more additional features, the one or more additional cavities sized and shaped to receive the curable material, the one or more additional mold frames configured to be removably coupled to the first or second mold frame such that the one or more additional cavities is in fluid communication with the first and second cavities,
wherein, after the predetermined time period, the curable material disposed within the first, second, and one or more additional cavities forms a unitary casting defined by the first, second, and one or more additional features.

19. An interchangeable mold assembly comprising:
a first front mold frame comprising a front half of a first cavity;
a first back mold frame comprising a back half of the first cavity, the first back mold frame configured to releasably engage with the first front mold frame, such that the front and back halves of the first cavity are aligned to thereby define a first feature;
a second front mold frame comprising a front half of a second cavity;
a second back mold frame comprising a back half of the second cavity, the second back mold frame configured to releasably engage with the second front mold frame, such that the front and back halves of the second cavity are aligned to thereby define a second feature,
wherein the first front mold frame and the first back mold frame are configured to be removably coupled to the second front mold frame and the second back mold frame, respectively, such that, after a predetermined time period, a curable resin disposed within the first and second cavities when the first and second front mold frames are releasably engaged with the first and second back mold frames, respectively, forms a unitary casting defined by the first and second features.

20. A method for forming a unitary casting, the method comprising:
selecting a first mold frame comprising a first front mold frame comprising a front half of a first cavity, and a first back mold frame comprising a back half of the first cavity, the front and back halves of the first cavity defining a first feature when aligned;
selecting a second mold frame comprising a second front mold frame comprising a front half of a second cavity, and a second back mold frame comprising a back half of the second cavity, the front and back halves of the second cavity defining a second feature when aligned;
removably coupling the first mold frame to the second mold frame;
aligning the first and second front mold frames with the first and second back mold frames, respectively, to thereby align the front and back halves of the first and second cavities;
inserting a curable resin into the first and second cavities,
wherein, after a predetermined time period, the curable material disposed within the first and second cavities forms a unitary casting defined by the first and second features.
